(19) United States
(12) Patent Application Publication
(10) Pub. No.: US 2024/0069865 A1
(43) Pub. Date: Feb. 29, 2024

(54) FRACTIONAL LOGARITHMIC NUMBER SYSTEM ADDER

(71) Applicant: Xilinx, Inc., San Jose, CA (US)

(72) Inventors: Erwei Wang, London (GB); Samuel Richard Bayliss, Los Altos, CA (US); Philip James-Roxby, Longmont, CO (US)

(73) Assignee: Xilinx, Inc., San Jose, CA (US)

(21) Appl. No.: 17/894,873

(22) Filed: Aug. 24, 2022

(51) Int. Cl. G06F 7/483; G06F 7/499

(52) U.S. Cl. CPC G06F 7/4833; G06F 7/49942

(57) ABSTRACT

An adder for fractional logarithmic number system (FLNS) format operands includes a compare-and-swap circuit that inputs first and second FLNS operands represented by fixed point values and provides a greater one as operand x and a lesser or equal one as operand y. Sign bits are sₓ and s_{y} of x and y, respectively, qₓ and q_{y}, are integer portions of x and y, respectively, fraction portions of x and y have integer values rₓ and r_{y}, respectively. The compare-and-swap circuit is configured to provide sₓ as a sign bit, s_{z} of a sum z=x(1+y/x) for x≠0. A subtraction circuit subtracts (q_{y}+r_{y}/n)−(qₓ+rₓ/n) and outputs q_{α} and r_{α}, such that α=y/x, where n=2^{w}^{ᵣ} and wᵣ is a bit-width of rₓ and r_{y}. An approximation circuit provides an approximation of (1+α) to a nearest FLNS value, β, as fixed point value having an integer portion q_{β} and a fraction portion that has an integer value r_{β}. A summing circuit adds qₓ+rₓ/n+q_{β}+r_{β}/n in response to sₓ=s_{y}, and subtracts qₓ+rₓ/n−q_{β}−r_{β}/n in response to sₓ≠s_{y}, to provide the sum as a fixed point value having an integer portion q_{z} and a fraction portion that as an integer has a value r_{z}.

### TECHNICAL FIELD

The disclosure generally relates to adders for operands represented in a fractional logarithmic number system.

### BACKGROUND

In a logarithmic number system (LNS), the real value of a number is approximated by its nearest power of two. An LNS number is represented by the sign and logarithm of the absolute value of the number. LNS representations allow multiplication to be a simple addition of exponents. For low-precision neural network inference and training, which involve many multiplications, LNS representations can provide significant memory and computation savings.

Though LNS representations simplify multiplication and division, addition and subtraction become complicated. Addition and subtraction involve interpolation of a nonlinear function and use of lookup tables, which significantly increases memory and computation requirements.

### SUMMARY

A disclosed adder for fractional logarithmic number system (FLNS) format operands, includes a compare-and-swap circuit that is configured to input first and second FLNS operands represented by fixed point values and provide a greater one of the first and second operands as operand x, and provide a lesser or equal one of the first and second operands as operand y. The bits sₓ and s_{y} are sign bits of x and y, respectively, qₓ and q_{y}, are integer portions of x and y, respectively, and fraction portions of x and y that as integers have values rₓ and r_{y}, respectively. The FLNS operand x=sₓ·2^{q}^{ₓ}^{+r}^{ₓ}^{/n}, and y=s_{y}·2^{q}^{_{y}}^{+r}^{_{y}}^{/n}, n=2^{w}^{ᵣ}, where wᵣ is a bit-width of rₓ and r_{y}. The compare-and-swap circuit is configured to provide sₓ as a sign bit, s_{z} of a sum z=x(1+y/x) for x≠0. A subtraction circuit is configured to subtract (q_{y}+r_{y}/n)−(qₓ+rₓ/n) and output q_{α} and r_{α}, where α=y/x. An approximation circuit is configured to provide an approximation of (1+α) to a nearest FLNS value, β, as fixed point value having an integer portion q_{β} and a fraction portion that as an integer has a value r_{β}. A summing circuit is configured to add qₓ+rₓ/n+q_{β}+r_{β}/n in response to sₓ=s_{y}, and subtract qₓ+rₓ/n−q_{β}−r_{β}/n in response to sₓ≠s_{y}, and provide the sum as a fixed point value having an integer portion q_{z} and a fraction portion that as an integer has a value r_{z}.

A disclosed method for adding fractional logarithmic number system (FLNS) format operands includes inputting first and second FLNS operands represented by fixed point values to a compare-and-swap circuit and providing a greater one of the first and second operands as operand x, and providing a lesser or equal one of the first and second operands as operand y. The sign bits of of x and y are sₓ and s_{y}, respectively, qₓ and q_{y}, are integer portions of x and y, respectively, and fraction portions of x and y that as integers have values rₓ and r_{y}, respectively. The FLNS operand x=sₓ·2^{q}^{ₓ}^{+r}^{ₓ}^{/n}, and operand y=s_{y}·2^{q}^{_{y}}^{+r}^{_{y}}^{/n}, n=2^{w}^{ᵣ}, where wᵣ is a bit-width of rₓ and r_{y}. The method includes providing sₓ as a sign bit, s_{z} of a sum, z=x(1+y/x) for x≠0. The method includes subtracting by a subtraction circuit, (q_{y}+r_{y}/n)−(qₓ+rₓ/n) and outputting q_{α} and r_{α}, where α=y/x. The method includes approximating by an approximation circuit, an approximation of (1+α) as fixed point value having an integer portion q_{β} and a fraction portion that as an integer has a value r_{β}. The method includes adding by a summing circuit, qₓ+rₓ/n+q_{β}+r_{β}/n in response to sₓ=s_{y}, and subtracting qₓ+rₓ/n−q_{β}−r_{β}/n in response to sₓ≠s_{y}, and providing the sum as a fixed point value having an integer portion q_{z} and a fraction portion that as an integer has a value r_{z}.

Other features will be recognized from consideration of the Detailed Description and Claims, which follow.

### BRIEF DESCRIPTION OF THE DRAWINGS

Various aspects and features of the circuits and methods will become apparent upon review of the following detailed description and upon reference to the drawings in which:

FIG. 1 shows an exemplary circuit arrangement that implements a conversion-free FLNS adder;

FIG. 2 illustrates the thermometer function and mapping implemented by a first mapping circuit;

FIG. 3 illustrates the thermometer function and mapping implemented by a second mapping circuit;

FIG. 4 illustrates the mapping implemented by a third mapping circuit;

FIG. 5 shows an exemplary decision tree that implements the first mapping circuit;

FIG. 6 is a flowchart of an exemplary process of adding two FLNS operands; and

FIG. 7 is a block diagram depicting a System-on-Chip (SoC) that can implement the FLNS adder circuitry according to an example.

### DETAILED DESCRIPTION

In the following description, numerous specific details are set forth to describe specific examples presented herein. It should be apparent, however, to one skilled in the art, that one or more other examples and/or variations of these examples may be practiced without all the specific details given below. In other instances, well known features have not been described in detail so as not to obscure the description of the examples herein. For ease of illustration, the same reference numerals may be used in different diagrams to refer to the same elements or additional instances of the same element.

Fractional LNS (FLNS) formats have been used to improve LNS precision via fractional exponents. In an FLNS format, the exponent is represented by a quotient and a remainder. In the FLNS representation of a number x, where M is the bit-width of x,

x=sₓ*2^{\dot{x}/γ}, \dot{x}=0; 1; 2; . . . , 2^{M-1}−1;

where \dot{x} is an integer and γ is the base factor that controls the fractional exponent of the base. γ controls the quantization gap, which is the distance between successive representable values within the number system.

The FLNS expression of x can be alternatively stated as:

x=sₓ·2^{q}^{ₓ}^{+r}^{ₓ}^{/n}, qₓ∈ [symbol] , rₓ∈ [symbol] , n=2^{w}^{ᵣ}, rₓ<n

where qₓ and rₓ are the quotient and remainder of \dot{x}/γ, and wᵣ represents the bit-width of the remainder.

Prior approaches involving FLNS, have attempted to reduce the hardware resource requirements for performing addition operations by converting the operands to fixed point format and using lookup tables to determine the contribution of remainder of the exponent. However, the conversion between FLNS format and fixed point introduces extra overhead and can significantly degrade performance in applications such as neural networks.

The disclosed approaches avoid inefficiencies associated with converting operands to fixed point values and converting sums back to FLNS format while improving computational efficiency in adding FLNS format operands. Operands need not be converted from FLNS format to fixed point for accumulation. Avoiding the conversion of values between FLNS format and fixed-point format can significantly improve performance and reduce resource requirements in applications such as neural networks in which accumulated values from one layer are provided as input to the next layer for multiplications.

The disclosed methods and circuits provide a conversion-free FLNS adder of two operands. Each addition is performed by way of a subtraction circuit performing logarithmic division of the operand having the lesser absolute value by the operand having the greater absolute value, approximation circuitry estimating a nearest FLNS value of the result plus 1, and an adder circuit performing a logarithmic multiplication of the estimated value and the greater operand.

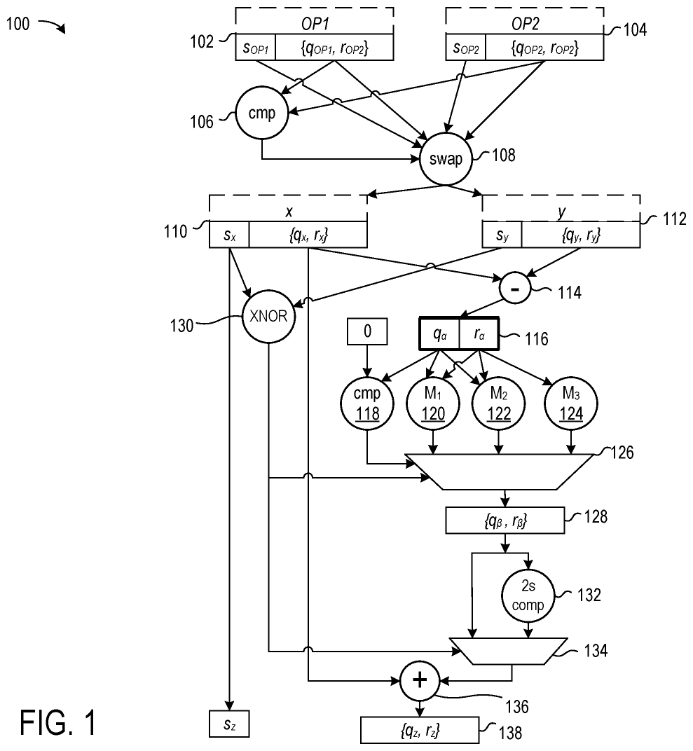

FIG. 1 shows an exemplary circuit arrangement 100 that implements a conversion-free FLNS adder. Calculating z=x+y can be alternatively expressed as z=x(1+α), where |x|>|y|, α=y/x, and x≠0. Having x and y in FLNS form, allows α to be determined by subtracting fixed point exponents:

α=s_{α}·2^{q}^{_{α}}^{+r}^{_{α}}^{/n}=sₓs_{y}·2^{q}^{_{y}}^{-q}^{ₓ}^{+r}^{_{y}}^{/n-r}^{ₓ}^{/n}

The term (1+α) can be approximated (1+α→β) to the nearest FLNS value, β=2^{q}^{_{β}}^{+r}^{_{β}}^{/n}, using a quantization mapping, 1+α→β, such that:

$$z \approx x \times β$$

$$\approx {2}^{{q}_{x} + {q}_{β} + {r}_{x} / n + {r}_{β / n}}$$

The sum, z, can be efficiently calculated by adding the exponents of x and β. Note that β>0 because |y|/|x|<1.

Referring to FIG. 1, FLNS format operands OP1 and OP2 are input from registers 102 and 104, respectively. Each of the FLNS operands can be in fixed-point two-complement form, having a sign bit (s_{OP1} and s_{OP2}) and exponent elements that include a quotient (q_{OP1} and q_{OP2}) and a remainder (r_{OP1} and r_{OP2}). The integer portion of OP1 is q_{OP1}, and the fractional portion of OP1 when interpreted as an integer is r_{OP1}. The integer portion of OP2 is q_{OP2}, and the fractional portion of q_{OP2} when interpreted as an integer is r_{OP2}. An example of a fixed point operand having a 4-bit integer portion and a 3-bit fraction portion is 0110.010. The integer portion q is 0110, which is 6₁₀, and the fraction portion is 010, which has an integer value of r=2.

Circuits 106 and 108 compare the exponent elements of OP1 and OP2 and provide the one of OP1 and OP2 having the greater absolute value as a fixed-point two-complement operand x in register 110 and the operand having the lesser absolute value as a fixed-point two-complement operand y in register 112.

Subtraction circuit 114 subtracts x from y (y−x=q_{y}−qₓ+r_{y}/n−rₓ/n) and stores the result in fixed-point two-complement form in register 116. The integer portion of the value in register 116 is q_{α}, and the fraction portion of the value in register 116 when interpreted as an integer is r_{α}.

Comparison circuit 118, mapping circuits M₁, M₂, and M₃, and selector circuit 126 form an approximation circuit. The approximation circuit that maps (1+α) to the nearest FLNS value, β=2^{q}^{_{β}}^{+r}^{_{β}}^{/n}. β is an FLNS value nearest to (1+2^{q}^{_{α}}^{+r}^{_{α}}^{/n}) in response to sₓ=s_{y}, and an FLNS value nearest to (1−2^{q}^{_{α}}^{+r}^{_{α}}^{/n}) in response to sₓ≠s_{y} (x+y=x*(1+y/x), and x−y=x*(1−y/x)).

The mapping circuits 120, 122, and 124 implement three different mappings, and the selector circuit selects the output from one of the mapping circuits. Each of mapping circuit M₁ and M₂ outputs an unsigned binary format integer r_{β}, and mapping circuit M₃ outputs unsigned binary integers q_{β} and r_{β}. The different mappings are based on mutually exclusive cases of the signs and ratio of |x| to |y|. The output of mapping M₁ (“case (i)”) is selected in response to sₓ=s_{y}, the output of mapping M₂ (“case (ii)”) is selected in response to sₓ≠s_{y} and |x|≥2|y|, and the output of mapping M₃ (“case (iii)”) is selected in response to sₓ≠s_{y} and |x|<2|y|<2|x|.

After swapping x and y such that |x|≥|y|, x+y is computed as x+y=x(1+y/x)≈x×2^{β}. If sₓ=s_{y}, then +y/x>1, 2^{β}>1, and β≥0. If sₓ≠s_{y}, then +y/x<1, 2^{β}<1, and β<0. Thus, for case i, β>0, and for cases ii and iii, β<0. To avoid twos-complement conversions for accessing the mapping circuits, the implemented mappings assume β>0, and β is applied differently between case i and cases ii and iii. For case i, +y≈x×2^{β}, and for cases ii and iii: x+y≈x×2^{-β}. The output from M₂ for case ii is r_{β}≥0, though the actual value of r_{β} for β in case ii is less than or equal to 0. The output from M₃ for case iii is q_{β}≥0 and r_{β}>0, though the actual value of q_{β} is less than or equal to 0 and r_{β} is less than 0. Given that the actual values of mappings for cases ii and iii are less than or equal to 0, the outputs from mapping circuits M₂ and M₃ are converted to negative twos-complement values.

The mappings have either n or n−1 entries. In mapping M₁, the sum z is bounded within range (x, 2x], i. e., (sₓ·2^{q}^{ₓ}^{+r}^{ₓ}^{/n}, sₓ·2^{q}^{ₓ}^{+r}^{ₓ}^{/n+1}]. In FLNS format, rₓ, n∈ [symbol] , and z has n discrete possible values, and therefore, the M₁ mapping has n meaningful discrete entries. The same is true in mapping M₂, where z is bounded within range [1/2 x, x), i.e., [sₓ·2^{q}^{ₓ}^{+r}^{ₓ}^{/n-1}, sₓ·2^{q}^{ₓ}^{+r}^{ₓ}^{/n}). In mapping M₃, −1/2<α<−1, i. e., −2⁻¹<−2^{q}^{_{α}}^{+r}^{_{α}}^{/n}<−2⁰, such that −1<q_{α}+r_{α}/n<0. Because α can only take one of n−1 possible values, meaning that the 1+α→β mapping M₃ contains n−1 meaningful discrete entries.

Selector circuit 126 selects one of the outputs from the mapping circuits 120, 122, and 124 based on the states of the signals from comparison circuit 118 and the signal from XNOR circuit 130. In response to sₓ=s_{y}, the selector circuit selects the output from mapping circuit 120 (M₁); in response to sₓ≠s_{y} and q_{α}≠0, the selector circuit selects the output from mapping circuit 122 (M₂); and in response to sₓ≠s_{y} and q_{α}=0, the selector circuit selects the output from mapping circuit 124 (M₃). The signed binary integers q_{β} and r_{β} are stored as a signed fixed point value in register 128. The integer portion of the value in register 128 is q_{β}, and the fraction portion of the value in register 128 when interpreted as an integer is r_{β}.

Note that q_{β}=0 is stored in register 128 when the output of mapping M₁, or M₂ is selected.

For case (i), the output of mapping M₁ is always a positive value, and for cases (ii) and (iii), the outputs of mappings M₂ and M₃ are negative but unsigned. Twos-complement converter circuit 132 converts the value from register 128 to a signed twos-complement value (invert integer bits and add 1 to LSB), and selector circuit 134 selects either the value from register 128 or the signed twos-complement value from converter circuit 132 in response to the signal from XNOR circuit 130. In response to sₓ=s_{y}, the signal from XNOR circuit causes selector circuit 134 to select the output from register 128, and in response to sₓ≠s_{y}, the signal from XNOR circuit causes selector circuit 134 to select the output from converter circuit 132.

Summing circuitry adds qₓ+rₓ/n+q_{β}+r_{β}/n in response to sₓ=s_{y}, and subtracts qₓ+rₓ/n−q_{β}−r_{β}/n in response to sₓ≠s_{y}, to provide the sum z as a fixed point value having an integer portion q_{z} and a fraction portion that as an integer has the value r_{z}, (s_{z}*2^{q}^{_{z}}^{+r}^{_{z}}^{/n}≈x+y. The summing circuitry includes two-complement converter 132, selector circuit 134, and adder 136.

The two-complement converter 132 is a circuit that converts the unsigned fixed point value from register 128 to a negative twos-complement value. The selector circuit 134 selects as an addend either the fixed point value from register 128 in response to the signal from XNOR circuit 130 indicating sₓ=s_{y}, or the negative twos-complement value from circuit 132 in response to the signal from the XNOR circuit indicating sₓ≠s_{y}. The adder circuit 136 adds the value from register 110 (without the sign bit sₓ) to the addend (without the sign bit if the twos-complement value is selected) selected by selector circuit 134 and provides the sum as a fixed point value in register 138.

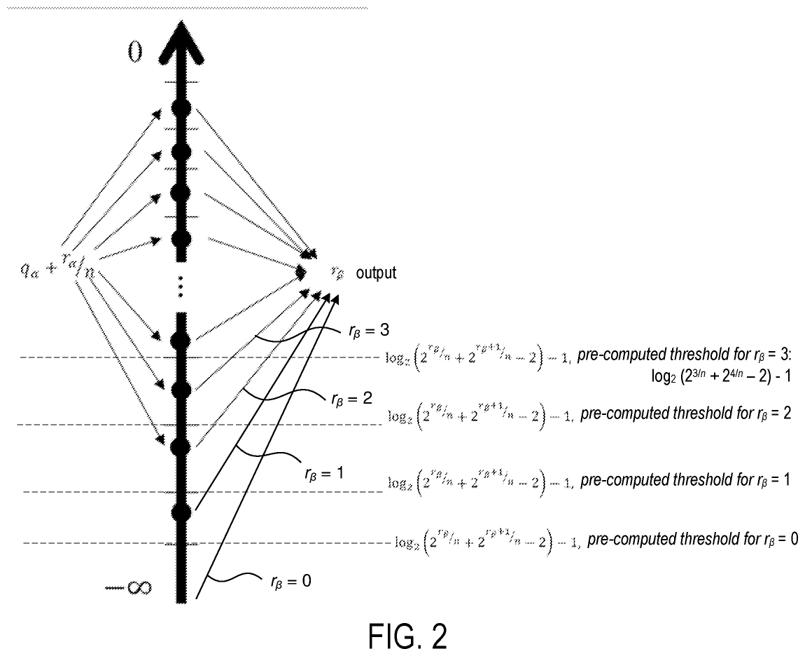

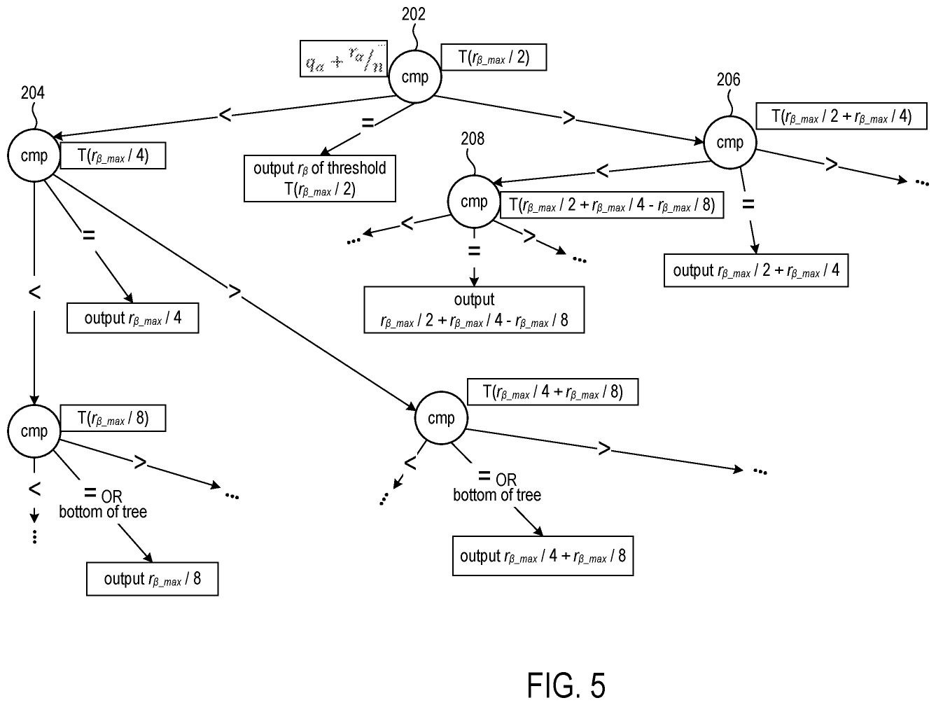

FIGS. 2, 3, and 4 illustrate the mapping of 1+α→β for cases i, ii, and iii, respectively. According to the disclosed approaches, the mappings of cases i and ii are implemented by thermometer functions. The thermometer functions, which can be implemented by decision tree circuits, map between the exponent of α, q_{α}+r_{α}/n, and the fractional exponent of β, r_{β}. FIG. 5 shows an exemplary implementation of the decision tree circuit for mapping M₁. The decision tree circuit for mapping M₂ would have different thresholds, but is not shown. Thermometer thresholds separating the entries can be pre-computed and configured into the decision tree circuits as constant values. The thresholds can be calculated by solving an inequality for each pair of adjacent entries. For example, the inequality for case (i) is:

∀r_{β}∈ [symbol] , r_{β}<n−1, 1+2^{q}^{_{α}}^{+r}^{_{α}}^{/n}−2^{r}^{_{β}}^{/n}≤2^{r}^{_{β}}^{+1/n}−1−2^{q}^{_{α}}^{+r}^{_{α}}^{/n}

which reduces to:

∀r_{β}∈ [symbol] , r_{β}<n, q_{α}+r_{α}/n≤log₂(2^{r}^{_{β}}^{/n}+2^{r}^{_{β}}^{+1/n}−2)−1,

The right-hand side of the inequality defines the threshold values. Similarly, the inequality at case (ii) is

∀r_{β}∈ [symbol] , r_{β}<n, q_{α}+r_{α}/n≤log₂(−2^{-r}^{_{β}}^{/n}−2^{-r}^{_{β}}^{-1/n}+2)−1

FIG. 2 illustrates the thermometer function and mapping implemented by the mapping circuit M₁ for case (i). The input is a fixed point value, q_{α}+r_{α}/n, and the output is an integer value of r_{β} that maps to the input. Each threshold is computed as log₂(2^{r}^{_{β}}^{/n}+2^{r}^{_{β}}^{+1/n}−2)−1 for one of the possible values of r_{β}. For example, the threshold computed for r_{β}=3 is: log₂(2^{3/n}+2^{4/n}−2)−1. A value of q_{α}+r_{α}/n≤log₂(2^{3/n}+2^{4/n}−2)−1 and greater than log₂(2^{2/n}+2^{3/n}−2)−1 maps to r_{β}=3.

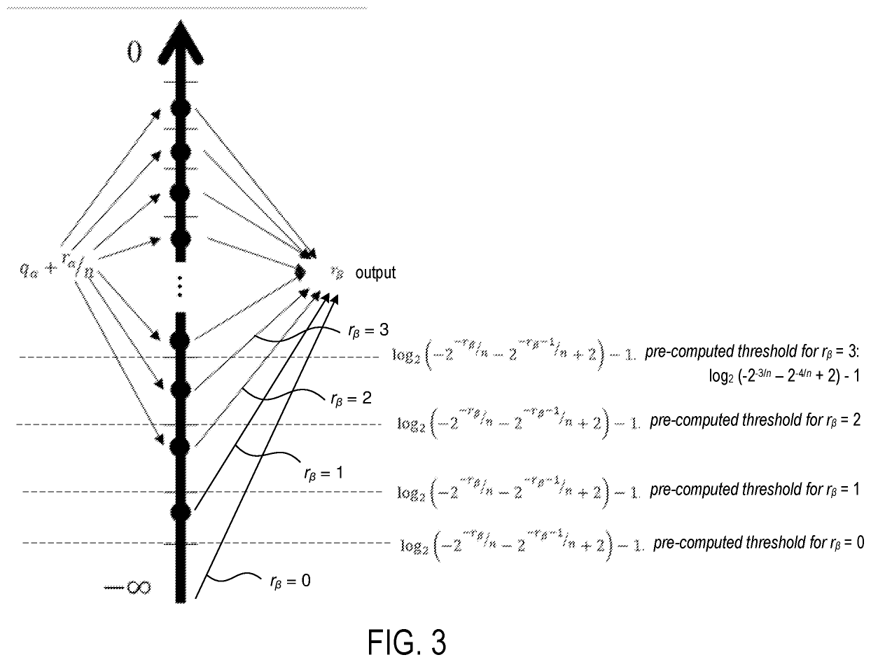

FIG. 3 illustrates the thermometer function and mapping implemented by the mapping circuit M₂ for case (ii). The input is a fixed point value, q_{α}+r_{α}/n, and the output is an integer value of r_{β} that maps to the input. Each threshold is computed as log₂(−2^{-r}^{_{β}}^{/n}−2^{-r}^{_{β}}^{-1/n}+2)−1 for one of the possible values of r_{β}. For example, the threshold computed for r_{β}=3 is: log₂(−2^{-3/n}−2^{-4/n}+2)−1. A value of q_{α}+r_{α}/n≤log₂(−2^{-3/n}−2^{-4/n}+2)−1 and greater than log₂(−2^{-2/n}−2^{-3/n}+2)−1 maps to r_{β}=3.

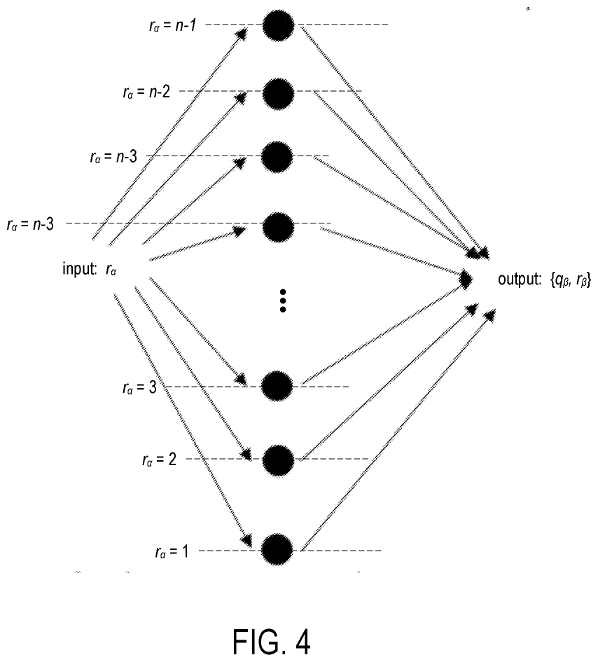

FIG. 4 illustrates the mapping implemented by the mapping circuit M₃ for case (iii). In case (iii), |x|<2|y|<2|x|, which means that x and y are close in magnitude. Because −1<−q_{α}−r_{α}/n<0, it is known that q_{α}=0, and r_{α}∈ [symbol] , 0<r_{α}<n. That is, there are n−1 discrete entries in the mapping of 1+α→β in case (iii). Given consecutive integer values of r_{α}, the mapping can be implemented as a lookup table (LUT) circuit having (n−1) entries.

The input to the LUT circuit is an integer value of r_{α}, and the output is a fixed point value, q_{β}+r_{β}/n, having q_{β} as the integer portion and the fraction portion r_{β} if interpreted as an integer. The values configured into the LUT circuit are pre-computed as −log₂(1−2^{-r}^{_{α}}^{/n}).

FIG. 5 shows an exemplary decision tree for the case (i) mapping. The decision tree searches for the interval between two thresholds into which an input fixed point value, q_{α}+r_{α}/n falls. Each comparison (“cmp”) compares the input fixed point value, q_{α}+r_{α}/n to a threshold and reduces the remaining search space by ½.

The maximum threshold, T(r_{β_max}), is the pre-computed threshold with the maximum possible value of r_{β}, and T(r_{β_min}), is the pre-computed threshold with the minimum possible value of r_{β}. Each threshold T(r_{β}) is computed as log₂(2^{r}^{_{β}}^{/n}+2^{r}^{_{β}}^{+1/n}−2)−1, as described above.

At the top of the search tree, comparison 202 compares q_{α}+r_{α}/n to T(r_{β_max}/2), which is the threshold at approximately the middle of the range values of r_{β}. Note that each division of r_{β_max} can be the floor of the result (i.e., floor (r_{β_max}/m) for m a power of 2 greater than 0).

In response to q_{α}+r_{α}/n being equal to the threshold T(r_{β_max}/2), the output value is r_{β_max}/2. In response to q_{α}+r_{α}/n<T(r_{β_max}/2), the decision tree continues with comparison 204 of q_{α}+r_{α}/n to T(r_{β_max}/4). In response to q_{α}+r_{α}/n>T(r_{β_max}/2), the decision tree continues with comparison 206 of q_{α}+r_{α}/n to T(r_{β_max}/2+r_{β_max}/4).

Comparison 206 compares q_{α}+r_{α}/n to T(r_{β_max}/2+r_{β_max}/4). In response to q_{α}+r_{α}/n being equal to the threshold T(r_{β_max}/2+r_{β_max}/4), the output value is r_{β_max}/2+r_{β_max}/4. In response to q_{α}+r_{α}/n<T(r_{β_max}/2+r_{β_max}/4), the decision tree continues with comparison 208 of q_{α}+r_{α}/n to T(r_{β_max}/2+r_{β_max}/4−r_{β_max}/8).

At comparison 208, in response to q_{α}+r_{α}/n<T(r_{β_max}/2+r_{β_max}/4−r_{β_max}/8), the decision tree continues with a comparison of q_{α}+r_{α}/n to T(r_{β_max}/2+r_{β_max}4/−r_{β_max}/8−r_{β_max}/16) (not shown). In response to q_{α}+r_{α}/n>T(r_{β_max}/2+r_{β_max}/4−r_{β_max}/8), the decision tree continues with a comparison of q_{α}+r_{α}/n to T(r_{β_max}/2+r_{β_max}/4+r_{β_max}/8+r_{β_max}/16) (not shown). In response to q_{α}+r_{α}/n being equal to the threshold T(r_{β_max}/2+r_{β_max}/4−r_{β_max}/8), the output value is r_{β_max}/2+r_{β_max}/4−r_{β_max}/8.

The search in the decision tree continues as described above until the q_{α}+r_{α}/n is equal to a threshold, or a comparison at the lowest level in the tree has been reached. At the lowest-level comparison, if q_{α}+r_{α}/n is less than the T(x), then the output is r_{β}=x. If q_{α}+r_{α}/n is greater than the T(x), then the output is r_{β}=x+1.

The decision tree can be implemented by a programmed processor or by programmable logic. The programmed processor can access a data structure having the threshold values and indexed by values of r_{β}. A programmable logic implementation can individual comparison circuits having pre-configured threshold values and associated values of r_{β}.

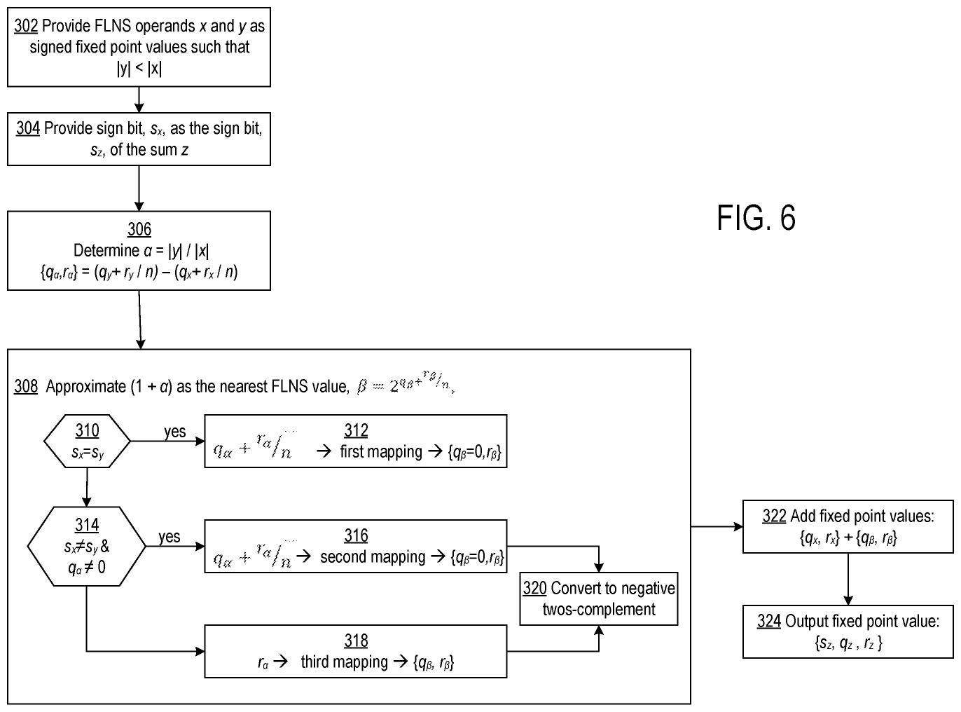

FIG. 6 is a flowchart of an exemplary process of adding two FLNS operands. At block 302, signed fixed point FLNS operands x and y are provided as input, with a swap circuit designating the lesser of the absolute values of the two operands as y and the other operand as x. The operands each have a sign bit, s, an integer part q, and a fractional part r.

At block 304, the sign bit of operand x is selected as the sign of the sum and can be stored in a register at the bit position of the sign bit of the signed fixed point sum.

At block 306, a subtraction circuit can determine |y|/|x| by subtracting (q_{y}+r_{y}/n)−(qₓ+rₓ/n), where (q_{y}+r_{y}/n) denotes the unsigned fixed point value of x, and (qₓ+rₓ/n) denotes the unsigned fixed point value of y. The difference is {q_{α}, r_{α}}, which denotes the unsigned fixed point value having an integer part q_{α}, and a fractional part that as an integer is denoted r_{α}.

At block 308, the term (1+α) is approximated (1+α→β) to the nearest FLNS value, β=2^{q}^{_{β}}^{+r}^{_{β}}^{/n}, using a quantization mapping as previously described. Decision block 310, in response to sₓ=s_{y}, selects the first mapping for case (i) as provided at block 312. Decision block 314, in response to sₓ≠s_{y} and q_{α}≠0, selects the second mapping for case (ii) as provided at block 316. In response to sₓ≠s_{y} and q_{α}=0, decision block 314 selects the third mapping for case (iii) as provided at block 318. For cases (i) and (ii), the mappings provide the mapped value of r_{β}, and q_{β}=0. For case (iii), the mapping provides the value of {q_{β}, r_{β}}. At block 320, the values {q_{β}, r_{β}} from the mappings of cases (ii) and (iii) are converted to negative twos-complement values.

At block 322, the fixed point values {qₓ, rₓ} and {q_{β}, r_{β}} are summed by and adder, and the result {q_{z}, q_{z}, r_{z}} is output at block 324.

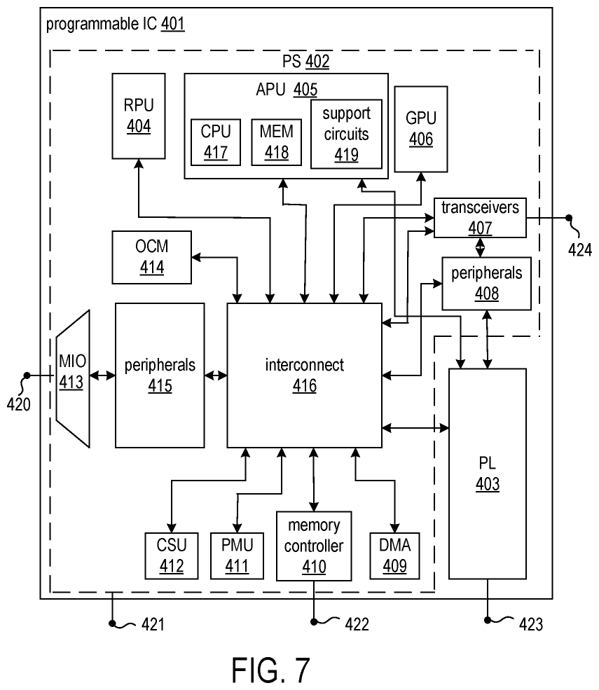

FIG. 7 is a block diagram depicting a System-on-Chip (SoC) 401 that can implement the FLNS adder circuitry according to an example. In the example, the SoC includes the processing subsystem (PS) 402 and the programmable logic subsystem 403. The processing subsystem 402 includes various processing units, such as a real-time processing unit (RPU) 404, an application processing unit (APU) 405, a graphics processing unit (GPU) 406, a configuration and security unit (CSU) 412, and a platform management unit (PMU) 411. The PS 402 also includes various support circuits, such as on-chip memory (OCM) 414, transceivers 407, peripherals 408, interconnect 416, DMA circuit 409, memory controller 410, peripherals 415, and multiplexed (MIO) circuit 413. The processing units and the support circuits are interconnected by the interconnect 416. The PL subsystem 403 is also coupled to the interconnect 416. The transceivers 407 are coupled to external pins 424. The PL 403 is coupled to external pins 423. The memory controller 410 is coupled to external pins 422. The MIO 413 is coupled to external pins 420. The PS 402 is generally coupled to external pins 421. The APU 405 can include a CPU 417, memory 418, and support circuits 419. The APU 405 can include other circuitry, including L1 and L2 caches and the like. The RPU 404 can include additional circuitry, such as L1 caches and the like. The interconnect 416 can include cache-coherent interconnect or the like.

Referring to the PS 402, each of the processing units includes one or more central processing units (CPUs) and associated circuits, such as memories, interrupt controllers, direct memory access (DMA) controllers, memory management units (MMUs), floating point units (FPUs), and the like. The interconnect 416 includes various switches, busses, communication links, and the like configured to interconnect the processing units, as well as interconnect the other components in the PS 402 to the processing units.

The OCM 414 includes one or more RAM modules, which can be distributed throughout the PS 402. For example, the OCM 414 can include battery backed RAM (BBRAM), tightly coupled memory (TCM), and the like. The memory controller 410 can include a DRAM interface for accessing external DRAM. The peripherals 408, 415 can include one or more components that provide an interface to the PS 402. For example, the peripherals can include a graphics processing unit (GPU), a display interface (e.g., DisplayPort, high-definition multimedia interface (HDMI) port, etc.), universal serial bus (USB) ports, Ethernet ports, universal asynchronous transceiver (UART) ports, serial peripheral interface (SPI) ports, general purpose (GPIO) ports, serial advanced technology attachment (SATA) ports, PCIe ports, and the like. The peripherals 415 can be coupled to the MIO 413. The peripherals 408 can be coupled to the transceivers 407. The transceivers 407 can include serializer/deserializer (SERDES) circuits, MGTs, and the like.

Various logic may be implemented as circuitry to carry out one or more of the operations and activities described herein and/or shown in the figures. In these contexts, a circuit or circuitry may be referred to as “logic,” “module,” “engine,” or “block.” It should be understood that logic, modules, engines and blocks are all circuits that carry out one or more of the operations/activities. In certain implementations, a programmable circuit is one or more computer circuits programmed to execute a set (or sets) of instructions stored in a ROM or RAM and/or operate according to configuration data stored in a configuration memory.

Though aspects and features may in some cases be described in individual figures, it will be appreciated that features from one figure can be combined with features of another figure even though the combination is not explicitly shown or explicitly described as a combination.

The circuits and methods are thought to be applicable to a variety of systems for adding FLNS operands. Other aspects and features will be apparent to those skilled in the art from consideration of the specification. The circuits and methods may be implemented as one or more processors configured to execute software, as an application specific integrated circuit (ASIC), or as a logic on a programmable logic device. It is intended that the specification and drawings be considered as examples only, with a true scope of the invention being indicated by the following claims.

What is claimed is:

1. An adder for fractional logarithmic number system (FLNS) format operands, comprising:
a compare-and-swap circuit configured to input first and second FLNS operands represented by fixed point values and provide a greater one of the first and second operands as operand x, and provide a lesser or equal one of the first and second operands as operand y, wherein sₓ and s_{y} are sign bits of x and y, respectively, qₓ and q_{y}, are integer portions of x and y, respectively, fraction portions of x and y that as integers have values rₓ and r_{y}, respectively, x=sₓ·2^{q}^{ₓ}^{+r}^{ₓ}^{/n}, y=s_{y}·2^{q}^{_{y}}^{+r}^{_{y}}^{/n}, n=2^{w}^{ᵣ}, wᵣ is a bit-width of rₓ and r_{y}, and the compare-and-swap circuit is configured to provide sₓ as a sign bit, s_{z} of a sum z=x(1+y/x) for x≠0;
a subtraction circuit configured to subtract (q_{y}+r_{y}/n)−(qₓ+rₓ/n) and output q_{α} and r_{α}, wherein α=y/x;
an approximation circuit configured to provide an approximation of (1+α) to a nearest FLNS value, β, as fixed point value having an integer portion q_{β} and a fraction portion that as an integer has a value r_{β}; and
a summing circuit configured to add qₓ+rₓ/n+q_{β}+r_{β}/n in response to sₓ=s_{y}, and subtract qₓ+rₓ/n−q_{β}−r_{β}/n in response to sₓ≠s_{y}, to provide the sum as a fixed point value having an integer portion q_{z} and a fraction portion that as an integer has a value r_{z}.

2. The adder of claim 1, wherein the approximation circuit is configured to provide β to the FLNS value nearest to (1+2^{q}^{_{α}}^{+r}^{_{α}}^{/n}) in response to sₓ=s_{y}, and the FLNS value nearest to (1−2^{q}^{_{α}}^{+r}^{_{α}}^{/n}) in response to sₓ≠s_{y}.

3. The adder of claim 1, wherein the approximation circuit is configured to:
map each range of a plurality of ranges of a plurality of possible values of q_{α}+r_{α}/n to a respective value of r_{β} according to a first mapping in response to sₓ=s_{y}; and
map each range of a plurality of ranges of a plurality of possible values of q_{α}+r_{α}/n to a respective value of r_{β} according to a second mapping in response to sₓ≠s_{y} and |x|≥2|y|.

4. The adder of claim 3, wherein the approximation circuit is configured to map each value of r_{α} to a respective pair of values of q_{β} and r_{β} according to a third mapping in response to sₓ≠s_{y} and |x|<2|y|<2|x|.

5. The adder of claim 4, wherein the approximation circuit includes a look-up table (124) that implements the third mapping.

6. The adder of claim 3, wherein the approximation circuit includes:
a first decision-tree circuit configured to implement the first mapping; and
a second decision-tree circuit configured to implement the second mapping.

7. The adder of claim 1, wherein the approximation circuit is configured to:
map each range of a plurality of ranges of a plurality of possible values of q_{α}+r_{α}/n to a respective value of r_{β} according to a first mapping in response to sₓ=s_{y}; and
map each range of a plurality of ranges of a plurality of possible values of q_{α}+r_{α}/n to a respective value of r_{β} according to a second mapping in response to sₓ≠s_{y} and q_{α}≠0.

8. The adder of claim 7, wherein the approximation circuit is configured to map each value of r_{α} to a respective pair of values of q_{β} and r_{β} according to a third mapping in response to sₓ≠s_{y} and q_{α}=0.

9. The adder of claim 1, wherein the summing circuit includes:
a twos-complement converter circuit configured to convert the fixed point value having q_{β} and r_{β} to a negative twos-complement value;
a selector circuit configured to select as an addend the fixed point value having q_{β} and r_{β} in response to sₓ=s_{y}, and select as the addend the negative twos-complement value in response to sₓ≠s_{y}; and
an adder circuit configured to add x to the addend.

10. The adder of claim 1, wherein the approximation circuit includes:
a first decision-tree circuit configured to map each range of a plurality of ranges of a plurality of possible values of q_{α}+r_{α}/n to a respective value of r_{β} according to a first mapping in response to sₓ=s_{y}, wherein the first decision-tree circuit is configured to compare q_{α}+r_{α}/n to threshold values of log₂(2^{r}^{_{β}}^{/n}+2^{r}^{_{β}}^{+1/n}−2)−1 for a plurality of values of r_{β}≥0; and
a second decision-tree circuit configured to map each range of a plurality of ranges of a plurality of possible values of q_{α}+r_{α}/n to a respective value of r_{β} according to a second mapping in response to sₓ≠s_{y} and q_{α}≠0, wherein the second decision-tree circuit is configured to compare q_{α}+r_{α}/n to threshold values of log₂(−2^{-r}^{_{β}}^{/n}−2^{-r}^{_{β}}^{-1/n}+2)−1 for a plurality of values of r_{β}≥0.

11. The adder of claim 10, wherein the approximation circuit includes a look-up table (124) that implements the third mapping, and the look-up table is configured with values of −log₂(1−2^{-r}^{_{α}}^{/n}) for r_{β}≥1.

12. A method for adding fractional logarithmic number system (FLNS) format operands, comprising:
inputting first and second FLNS operands represented by fixed point values to a compare-and-swap circuit and providing a greater one of the first and second operands as operand x, and providing a lesser or equal one of the first and second operands as operand y, wherein sₓ and s_{y} are sign bits of x and y, respectively, qₓ and q_{y}, are integer portions of x and y, respectively, fraction portions of x and y that as integers have values rₓ and r_{y}, respectively, x=sₓ·2^{q}^{ₓ}^{+r}^{ₓ}^{/n}, y=s_{y}·2^{q}^{_{y}}^{+r}^{_{y}}^{/n}, n=2^{w}^{ᵣ}, wᵣ is a bit-width of rₓ and r_{y};
providing sₓ as a sign bit, s_{z} of a sum, z=x(1+y/x) for x≠0;
subtracting by a subtraction circuit, (q_{y}+r_{y}/n)−(qₓ+rₓ/n) and outputting q_{α} and r_{α}, wherein α=y/x;
approximating by an approximation circuit, an approximation of (1+α) as fixed point value having an integer portion q_{β} and a fraction portion that as an integer has a value r_{β}; and
adding by a summing circuit, qₓ+rₓ/n+q_{β}+r_{β}/n in response to sₓ=s_{y}, and subtracting qₓ+rₓ/n−q_{β}−r_{β}/n in response to sₓ≠s_{y}, and providing the sum as a fixed point value having an integer portion q_{z} and a fraction portion that as an integer has a value r_{z}.

13. The method of claim 12, wherein β is an FLNS value nearest to (1+2^{q}^{_{α}}^{+r}^{_{α}}^{/n}) in response to sₓ=s_{y}, and the FLNS value nearest (1−2^{q}^{_{α}}^{+r}^{_{α}}^{/n}) in response to sₓ≠s_{y}.

14. The method of claim 12, wherein the approximating includes:
mapping each range of a plurality of ranges of a plurality of possible values of q_{α}+r_{α}/n to a respective value of r_{β} according to a first mapping in response to sₓ=s_{y}; and
mapping each range of a plurality of ranges of a plurality of possible values of q_{α}+r_{α}/n to a respective value of r_{β} according to a second mapping in response to sₓ≠s_{y} and |x|≥2|y|.

15. The method of claim 14, wherein the approximating includes mapping each value of r_{α} to a respective pair of values of q_{β} and r_{β} according to a third mapping in response to sₓ≠s_{y} and |x|<2|y|<2|x|.

16. The method of claim 15, wherein the approximating includes performing the third mapping by a look-up table.

17. The method of claim 14, wherein the approximating includes:
performing the first mapping by a first decision-tree circuit; and
performing the second mapping by a second decision-tree circuit.

18. The method of claim 12, wherein the approximating includes:
mapping each range of a plurality of ranges of a plurality of possible values of q_{α}+r_{α}/n to a respective value of r_{β} according to a first mapping in response to sₓ=s_{y}; and
mapping each range of a plurality of ranges of a plurality of possible values of q_{α}+r_{α}/n to a respective value of r_{β} according to a second mapping in response to sₓ≠s_{y} and q_{α}≠0.

19. The method of claim 12, wherein the approximating includes:
mapping by a first decision-tree circuit, each range of a plurality of ranges of a plurality of possible values of q_{α}+r_{α}/n to a respective value of r_{β} according to a first mapping in response to sₓ=s_{y}, and comparing q_{α}+r_{α}/n to threshold values of log₂(2^{r}^{_{β}}^{/n}+2^{r}^{_{β}}^{+1/n}−2)−1 for a plurality of values of r_{β}≥0; and
mapping by a second decision-tree circuit, each range of a plurality of ranges of a plurality of possible values of q_{α}+r_{α}/n to a respective value of r_{β} according to a second mapping in response to sₓ≠s_{y} and q_{α}≠0, and comparing q_{α}+r_{α}/n to threshold values of log₂(−2^{-r}^{_{β}}^{/n}−2^{-r}^{_{β}}^{-1/n}+2)−1 for a plurality of values of r_{β}≥0.

20. The method of claim 19, wherein the approximating includes mapping by a look-up table configured with values of −log₂(1−2^{-r}^{_{α}}^{/n}) for r_{β}≥1.
